(19) United States
(12) Patent Application Publication
(10) Pub. No.: US 2004/0258302 A1
(43) Pub. Date: Dec. 23, 2004

(54) Image processor, image processing method and program

(75) Inventors: Shinji Miwa, Nirasaki-shi (JP); Naoki Kayahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/816,831

(22) Filed: Apr. 5, 2004

(30) Foreign Application Priority Data
Apr. 8, 2003 (JP) 2003-103903

(51) Int. Cl. G06K 9/00; G06K 9/40

(52) U.S. Cl. 382/167; 382/274

(57) ABSTRACT

The invention can provide an image processor, an image processing method and a program capable of reducing an oddness of appearance when plural images of different color tones photographed in different conditions, etc. are arranged on the same page. The image processor can unify the color tones of plural correcting object images, and is characterized in that a reference color which is a representative color of the correcting object image is set for every correcting object image, and the color tone of a partial area or an entire area of the correcting object image is corrected so as to conform the reference color for every correcting object image.

### BACKGROUND OF THE INVENTION

1. Technical Field of the Invention

The present invention relates to an image processor, an image processing method and a program. The present invention particularly relates to an image processor, an image processing method and a program for unifying the color tones of images with respect to the plural images of different color tones in accordance with a photographing condition, and the like.

2. Description of Related Art

When plural images are arranged on the same page as in one screen, one sheet of paper, etc., there is a case in which the plural images of different color tones in accordance with the photographing condition, etc. are arranged. Therefore, various methods for unifying the color tones while correcting the images by displaying the plural images in a display device have been proposed.

For example in JP-A-9-298657 there is proposed a method in which the plural images are displayed in the display device and an image processing condition is set with respect to each of the images and a correcting image having unifying color tone, gradation, density, etc. is outputted. Further, JP-A-11-275351 proposes a method in which a specific area within one image among plural images is designated and the image is corrected so that similar correction processing is performed in similar areas of the other images.

### SUMMARY OF THE INVENTION

However, in the invention of the JP-A-9-298657, a problem exists in that each of the images cannot be partially corrected. Further, since a user must set a correction function of a gradation correction, color conversion, density conversion, etc. for every image, a problem exists in that it is complicated to set the correction function.

In the invention of the JP-A-11-275351, when the same photographed object is photographed in the same way in the plural images and an additional correction is made with this photographed object within one image, the other images can be similarly corrected. However, a problem exists in that no correction is made with respect to a portion shifted in characteristics between the images. Further, there is also no processing of similarly correcting this portion shifted in characteristics.

Further, in the above inventions, since an adjustment in the correction processing of the image is executed by the user, special ability and skill are required in the user.

The present invention is made to solve the above problems, and an object of the present invention is to provide an image processor, an image processing method and a program capable of reducing an oddness of appearance when the plural images of different color tones photographed in different conditions, etc. are arranged on the same page.

The following inventions are provided in view of the above conventional problems.

The invention can reside in an image processor for unifying the color tones of plural correcting object images, and can include an image selecting device for selecting the plural correcting object images as a correcting object from plural images, and an image correcting device for setting a reference color which is a representative color of the correcting object image for every correcting object image, and correcting the color tone of the correcting object image such that the reference colors set for every correcting object image are conformed. In accordance with such a construction, when a user selects plural images desirous to be arranged on the same page as the correcting object image from the plural images by the image selecting device, the plural selected correcting object images are corrected to images for unifying the reference colors of the reference area set for every correcting object image by the image correcting device. Thus, when the plural images of different color tones in accordance with a photographing condition, etc. are arranged on the same page, the oddness of appearance of the color tone of the image can be reduced. Further, the image can be easily corrected without performing a complicated setting operation of the correction processing by the user for every image or photographed object. Further, the user can perform the image correction processing irrespective of the photographed condition, etc. merely by selecting the image for unifying the color tone of the image. Accordingly, the user can perform the operation of the image correction even when user has no special ability and skill.

The invention can also reside in the image processor as described above and further include a processing condition selecting device for making a user select one or plural correction processing conditions of the correction processing executed by the image correcting device through an input device. In accordance with such a construction, when the user selects one or plural correction processing conditions in the correction processing by the processing condition selecting device and also selects plural images desirous to be arranged on the same page from the plural images as correcting object images by the image selecting device, the plural selected correcting object images are corrected to images for unifying the reference color of the reference area set for every correcting object image by the image correcting device on the basis of the correction processing of the selected correction processing condition.

Thus, the image can be easily corrected without performing a complicated setting operation of the correction processing by the user for every image or photographed object. Further, the user can perform the image correction processing merely by selecting the image for unifying the color tone of the image irrespective of a photographed condition, etc. Accordingly, the user can perform the operation of the image correction even when user has no special ability and skill.

The invention can reside in the above-described image processor, wherein the image correcting device has a reference color setting device for setting a reference area which is a partial area or an entire area of the correcting object image for every correcting object image, and setting the representative color calculated on the basis of the pixel information of a pixel constituting the set reference area as the reference color, a target color setting device for setting, as a target color, a color after the correction common to the each correcting object image when the reference colors set for every correcting object image by the reference color setting device are conformed, and a pixel information correcting device for setting the correcting amount of the color tone of the each pixel in accordance with a changing degree when the reference color is changed to the target color, and correcting the pixel information of the each pixel on the basis of the set correcting amount.

In accordance with such a construction, the reference color is set for every correcting object image by the reference color setting device, and the target color which is the color of a target for changing the reference color is set by the target color setting device. The color tone of a pixel is corrected in accordance with the degree of the change from the reference color to the target color by the pixel information correcting device. Thus, when the plural images of different color tones in accordance with the photographing condition, etc. are arranged on the same page, the oddness of appearance of the color tone of the image can be reduced.

The invention can reside in the above image processor, wherein one of the following areas is set as the reference area: (a1) all areas of the correcting object image; (a2) the image object area having a maximum area within plural image object areas constituting the correcting object image; (a3) an area recognized as a common shape and existing within the plural correcting object images; (a4) an arbitrary area within the correcting object image designated by a user through an input device; and (a5) the image object area of the correcting object image including an arbitrary portion within the correcting object image designated by the user through the input device.

Thus, when the area of (a1) is set in the reference area, largest color tones within the plural correcting object images can be conformed by setting a color near the color of high frequency in the pixel of the correcting object image to the reference color. Further, when the area of (a2) is set to the reference area, the color tones can be conformed with a background portion of the plural correcting object images as a reference in e.g., an image in which the background occupies a large area. Further, when the area of (a3) is set to the reference area, the color tones of the image object area common to the plural correcting object. images can be conformed. Further, when the area of (a4) is set to the reference area, the user can select an area to be clearly conformed. Further, when the area of (a5) is set to the reference area, the image object area to be clearly conformed can be selected even when a portion designated by the user is one point of the image object area.

The invention can also reside in the above-described image processor, wherein the pixel information correcting device corrects the correcting amount of the pixel information of the pixel with respect to only the pixel existing in the image object area including the reference color and a color near the reference color. Thus, the image correction can be made with respect to only the pixel belonging to the image object area including the reference color and a color near the reference color.

The invention can also reside in the above image processor, wherein the pixel information correcting device corrects the correcting amount of the pixel information of the pixel with respect to all the pixels of the correcting object image. Thus, the image correction can be made with respect to all the belonging pixels of the correcting object image.

The invention can further reside in the image processor, wherein the pixel information correcting device can have a correcting amount detecting device for detecting the correcting amount when the reference color is changed to the target color so as to conform the reference color and the target color, and a correcting amount adjusting device for adjusting the correcting amount of the pixel information of the pixel on the basis of the pixel information of the pixel as the correcting object of the correcting object image and the correcting amount detected by the correcting amount detecting device.

In accordance with such a construction, the correcting amount for conforming the reference color to the target color is detected by the correcting amount detecting device, and the correcting amount for correcting the pixel information of this pixel can be adjusted for every pixel by the correcting amount adjusting device. Thus, when the plural images of different color tones in accordance with the photographing condition, etc. are arranged on the same page, the oddness of appearance of the color tone of the image can be reduced.

The invention can further reside in the image processor, wherein the correcting amount adjusting device adjusts the correcting amount in accordance with the distance between the reference area and the pixel. Thus, while the correcting amount of the color tone of the pixel of a specific reference area within the correcting object image is uniformly corrected, the correcting amount of the color tone of the pixel is reduced as it is separated from the reference area, and the oddness of appearance in the color tones of the reference area and its circumference can be avoided.

The invention can reside in the above image processor, wherein the correcting amount adjusting device adjusts the correcting amount in accordance with the distance between the reference area and the image object area to which the pixel belongs. Thus, while the correcting amount of the color tone of the pixel of a specific reference area within the correcting object image is uniformly corrected, the correcting amount of the color tone of the pixel of the image object area separated from the reference area is reduced, and the oddness of appearance in the color tones of the reference area and its circumference is avoided. Further, the pixel of the image object area can be uniformly corrected.

The invention can also reside in the above image processor, wherein the correcting amount adjusting device adjusts the correcting amount so as to be constant irrespective of the characteristics of the color of the pixel. Thus, the image correction can be made by the same correcting amount with respect to the pixels of all colors. Accordingly, it is effective when the color tone of the entire image is shifted in one direction by the influence of a light source at a photographing time and the characteristics of a photographing device.

The invention can reside in the image processor, wherein the correcting amount adjusting device adjusts the correcting amount in accordance with the difference between the characteristics of the reference color and the characteristics of the color of the pixel. Thus, the correcting amount is increased in a color near the reference color and is decreased with respect to a color having a large difference with the reference color, and the correction of the pixel of a color separated from the reference color can be avoided.

The invention resides in the image processor, the correcting amount adjusting device adjusts the correcting amount in accordance with the difference between the characteristics of the reference color and the characteristics of the representative color of the image object area to which the pixel belongs. Thus, the correcting amount of the pixel of the image object area with the color near the reference color as a representative color is uniformly increased and the correcting amount of the pixel of the image object area with the color having a large difference with the reference color as a representative color is uniformly decreased for every image object area. Accordingly, the correction of the pixel of the image object area with a color separated from the reference color as a representative color is avoided, and the pixel of the image object area can be uniformly corrected.

The invention can further reside in an image processing method for unifying the color tones of plural correcting object images and include an image selecting process for selecting the plural correcting object images as a correcting object from plural images, and an image correcting process for setting a reference color which is a representative color of the correcting object image for every correcting object image, and correcting the color tone of the correcting object image so as to conform the reference colors set for every correcting object image. Thus, when the plural images of different color tones in accordance with a photographing condition, etc. are arranged on the same page, the oddness of appearance of the color tone of the image can be reduced. Further, the image can be easily corrected for every image or photographed object without performing a complicated setting operation of the correction processing by a user. Further, the user can perform the image correction processing irrespective of the photographed condition, etc. merely by selecting an image for unifying the color tone of the image. Accordingly, the user can perform the operation of the image correction even when user has no special ability and skill.

The invention can additionally reside in the above-described image processing method that can further include a processing condition selecting process for making a user select one or plural correction processing conditions of the correction processing executed by the image correcting process through an input device. Thus, the image can be easily corrected for every image or photographed object without performing a complicated setting operation of the correction processing by the user. Further, the user can perform the image correction processing irrespective of the photographed condition, etc. merely by selecting an image for unifying the color tone of the image. Accordingly, the user can perform the operation of the image correction even when user has no special ability and skill.

The invention can reside in a program for executing image processing for unifying the color tones of plural correcting object images by a computer, and executing the following processes of an image processing method by the computer. The process can include an image selecting process for selecting the plural correcting object images as a correcting object from plural images, and an image correcting process for setting a reference color which is a representative color of the correcting object image for every correcting object image, and correcting the color tone of the correcting object image so as to conform the reference colors set for every correcting object image.

In accordance with such a construction, when the program is read by the computer and the computer executes processing by the read program, an operation similar to that of the image processor above-described invention can be obtained. Thus, when the plural images of different color tones in accordance with the photographing condition, etc. are arranged on the same page, the oddness of appearance of the color tone of the image can be reduced. Further, the image can be easily corrected for every image or photographed object without performing a complicated setting operation of the correction processing by the user. Further, the user can perform the image correction processing irrespective of the photographed condition, etc. merely by selecting an image for unifying the color tone of the image. Accordingly, the user can perform the operation of the image correction even when user has no special ability and skill.

The invention can also reside in the above-described program, wherein the computer further executes a processing condition selecting process for making a user select one or plural correction processing conditions of the correction processing executed by the image correcting process through an input device. In accordance with such a construction, when the program is read by the computer and the computer executes processing by the read program, an operation similar to that of the image processor above-described invention can be obtained. Thus, the image can be easily corrected for every image or photographed object without performing a complicated setting operation of the correction processing by the user. Further, the user can perform the image correction processing irrespective of the photographed condition, etc. merely by selecting an image for unifying the color tone of the image. Accordingly, the user can perform the operation of the image correction even when user has no special ability and skill.

### BRIEF DESCRIPTION OF THE DRAWINGS

The invention will be described with reference to the accompanying drawings, wherein like numerals reference like elements, and wherein:

FIG. 1 is an exemplary block diagram of an image processor;

FIG. 2 shows one example of a functional block diagram of the image processor;

FIG. 3 shows one example of a view showing screen display for urging a user to an image selection;

FIG. 4 shows one example of a view showing an adjusting function of a correcting amount;

FIG. 5(a) is a schematic view for similarly adjusting an entire color space, and FIG. 5(b) is a schematic view for adjusting the correcting amount based on the difference between the characteristics of a reference color and the characteristics of a pixel of a correcting object;

FIG. 6 is a view showing a display example of a list of setting items of image correction processing;

FIG. 7 shows one example of a flow chart of image processing;

FIG. 8 shows one example of a flow chart of the image correction processing;

FIG. 9 shows one example of a flow chart of reference color setting processing;

FIG. 10 shows one example of a flow chart of the reference color setting processing continued from FIG. 9;

FIG. 11 shows one example of a schematic view of a correcting object image;

FIG. 12 shows one example of a flow chart of correcting amount adjustment processing;

FIG. 13 shows one example of a flow chart of the correcting amount adjustment processing continued from FIG. 12;

FIG. 14 shows one example of a flow chart of the correcting amount adjustment processing continued from FIG. 12; and

FIG. 15 shows one example of a flow chart of the correcting amount adjustment processing continued from FIG. 12.

### DETAILED DESCRIPTION OF PREFERRED EMBODIMENTS

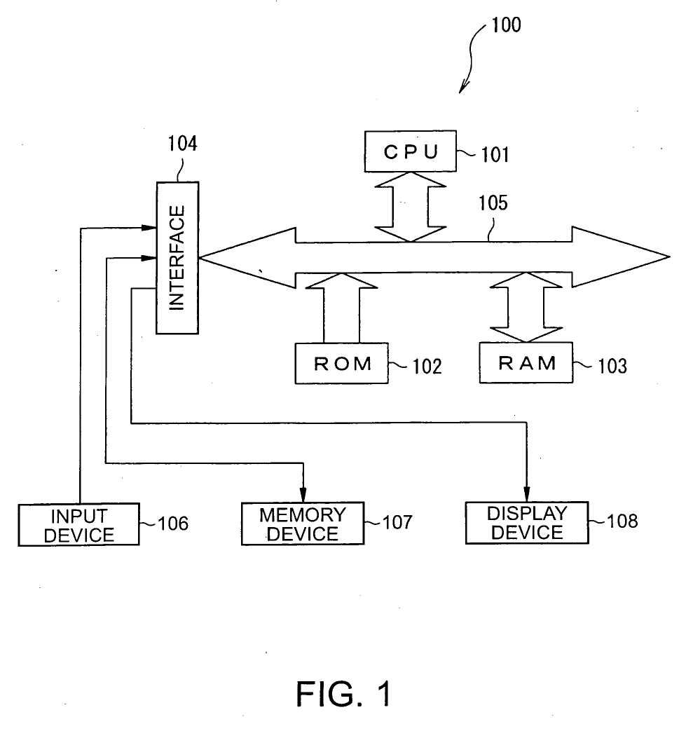

One embodiment of this invention will be explained with reference to the drawings. FIG. 1 is a constructional view of an image processor. As shown in FIG. 1, the image processor 100 has a CPU 101 for controlling an arithmetic operation and the operation of the entire device on the basis of a control program, a ROM 102 storing the control program of the CPU 101, etc. to a predetermined area in advance, a RAM 103 for storing information read from the ROM 102, etc. and a required arithmetic result in the arithmetic process of the CPU 101, and an interface 104 for mediating the input and output of information with respect to an external device. These members can be connected to each other so as to give and receive information via a bus 105 which is a signal line for transferring information.

An input device 106, such as a keyboard, a mouse, etc. capable of inputting data, a memory device 107 storing the image information of an image as an object of image processing, and a display device 108 for displaying the results of the image processing on the screen, etc. are connected to the interface 104 as the external device.

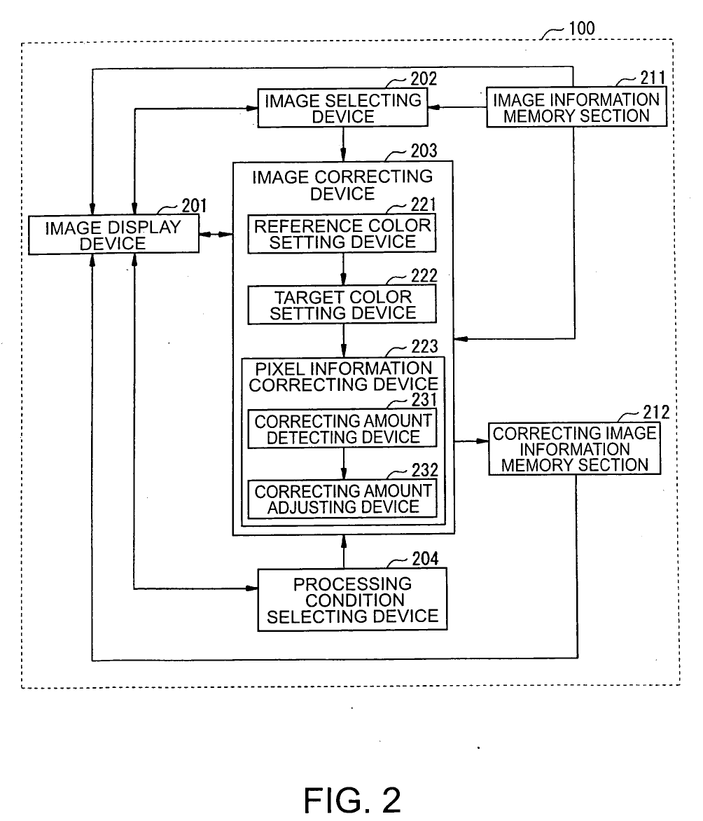

FIG. 2 shows one example of a functional block diagram of the image processor. As shown in FIG. 2, the image processor 100 has an image display device 201, an image selecting device 202, an image correcting device 203 and a processing condition selecting device 204.

The image display device 201 can read the image information of plural images stored to an image information memory section 211 in advance by an unillustrated image input device, and displays the image information in the display device 108. Selecting instruction information to a user, the image information during the image processing, the image information of a corrected image, etc. are displayed in the image processing. Further, the image display device 201 has a preview function and displays a processing midway result and a processing result as resized image. The image selecting device 202 makes the user select an image as a processing object of the image correction among the plural images through the input device 106.

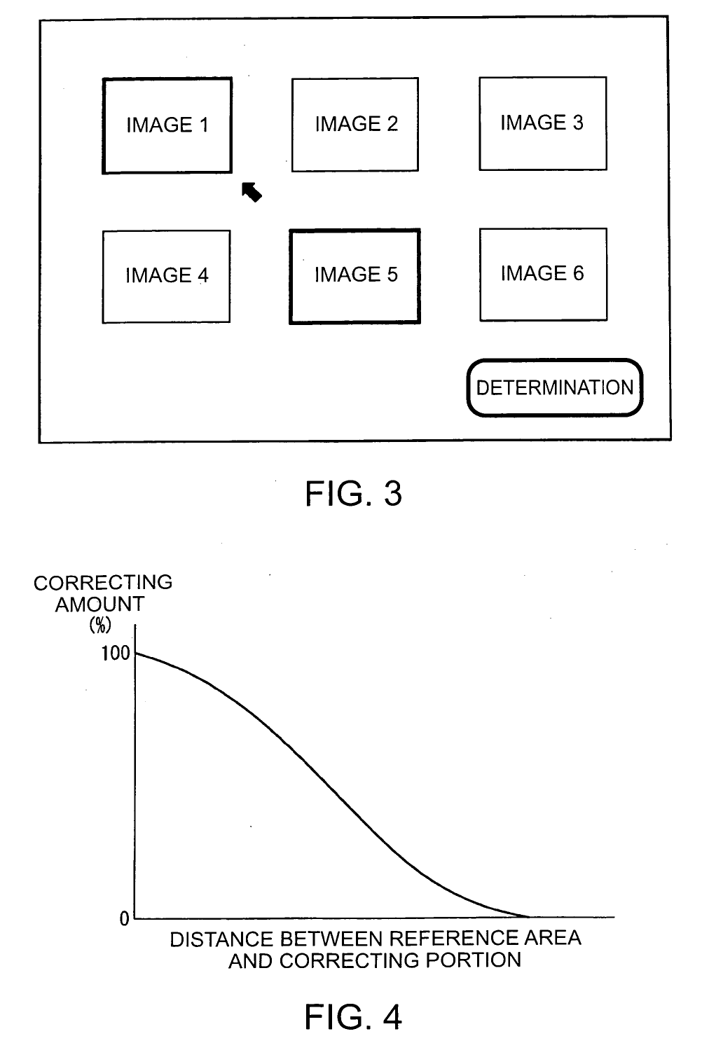

FIG. 3 shows one example of a view showing screen display to let the users select the images. As shown in FIG. 3, an image (hereinafter called reduced image) provided by reducing the image stored to the image information memory section 211 in size is displayed by the image display device 201. The user selects the reduced image as a processing object of the image correction by utilizing a mouse, etc. Here, the arrow of FIG. 3 shows a mouse cursor. Further, in FIG. 3, the preview image selected by the user is shown by a thick frame. Further, the image as a processing object of the image correction is determined by designating the rightward lower “determination” button.

The image correcting device 203 sets the correcting amount of a pixel as a correcting object with respect to the image selected by the image selecting device 202, and corrects the pixel information of the pixel by this correcting amount. Further, the corrected image information is stored to a correcting image information memory section 212. The image correcting device 203 has a reference color setting device 221, a target color setting device 222 and a pixel information correcting device 223.

The reference color setting device 221 sets an area (hereinafter called a reference area) as a correcting reference of the image (hereinafter called a correcting object image) as a correcting object, and calculates a representative color of the reference area based on the pixel information of the pixel constituting the set reference area, and sets the calculated representative color to a reference color. Here, in the calculation of the representative color, a color near a color having a largest pixel number among the colors of pixels constituting the area is set to the representative color, and an average value of the colors of all the pixels constituting the reference area is also set to the representative color. Here, the following area is set as the reference area.

(a1) All the areas of the correcting object image are set to the reference area.

(a2) The image object area of a maximum area within plural image object areas constituting the correcting object image is set to the reference area.

(a3) An area recognized as a common shape and existing within plural correcting object images is set to the reference area.

(a4) An area within the correcting object image designated by a user is set to the reference area.

(a5) The image object area including a portion within the correcting object image designated by the user is set to the reference area.

The target color setting device 222 can set a target color which is the color of a target for converting a reference color set for every correcting object image by the reference color setting device 221 to unify the color tones of all the correcting object images selected by the image selecting device 202. Here, for example, an average value of the reference color set for every correcting object image is set to the target color, and one of the reference color and plural colors between the reference colors is set to the target color.

The pixel information correcting device 223 sets the correcting amount of the color tone of a pixel in accordance with the degree of a change when the reference color set by the reference color setting device 221 is changed to the target color set by the target color setting device 222. The pixel information correcting device 223 also corrects the characteristics of the pixel on the basis of the above set correcting amount. Namely, the pixel information of the pixel constituting the correcting image which is an image after the correction is newly calculated. The calculated pixel information is stored to the correcting image information memory section 212.

The pixel information correcting device 223 has a correcting amount detecting device 231 and a correcting amount adjusting device 232.

The correcting amount detecting device 231 detects a correcting amount (hereinafter called a reference correcting amount) for correcting the reference color of the correcting object image to the target color for every correcting object image.

The correcting amount adjusting device 232 adjusts the correcting amount of the color tone of the pixel on the basis of the reference correcting amount detected by the correcting amount detecting device 231 and the image information of the pixel as a correcting object. Here, one of the following adjustments depending on the position of the pixel and one of the adjustments depending on the pixel color are made as the adjustment of the correcting amount.

The following description relates to the adjustment of the correcting amount depending on the pixel position.

(b1) The color tone of the pixel is corrected with respect to only the pixel existing in the image object area including the reference color and a color near the reference color.

(b2) The color tone of the pixel is corrected with respect to all the pixels of the correcting object image.

(b3) On the basis of the distance between the reference area and the pixel, the correcting amount with respect to the pixel is adjusted so as to be reduced as the distance is increased. Here, the distance between the reference area and the pixel of the correcting object is the distance between the center of a nearest pixel of the reference area and the center of the pixel of the correcting object, the distance between the center of a farthest pixel of the reference area and the center of the pixel of the correcting object, the distance between the center of gravity of the reference area and the center of the pixel of the correcting object, etc.

FIG. 4 shows one example of a view showing an adjusting function of the correcting amount. As shown in FIG. 4, this function becomes an adjusting function of the correcting amount in which the correcting amount of the color tone is increased as the distance with respect to the reference area is near, and the correcting amount of the color tone is decreased as this distance is far.

(b4) The adjustment is made so as to reduce the correcting amount with respect to the pixel as the distance is increased on the basis of the distance between the reference area and the image object area to which the pixel belongs. Here, the distance between areas is the distance between nearest points of the respective areas, the distance between farthest points, the distance between centers of gravity, etc.

The following description relates to the adjustment of the correcting amount depending on the pixel color.

(c1) The adjustment is made so as to set the correcting amount to be constant irrespective of the characteristics of the pixel color.

(c2) On the basis of the difference between the characteristics of the reference color and the characteristics of the pixel color, the adjustment is made so as to reduce the correcting amount with respect to the pixel as the difference is increased.

(c3) On the basis of the difference between the characteristics of the reference color and the characteristics of a representative color of the image object area to which the pixel belongs, the adjustment is made so as to reduce the correcting amount with respect to the pixel as the difference is increased.

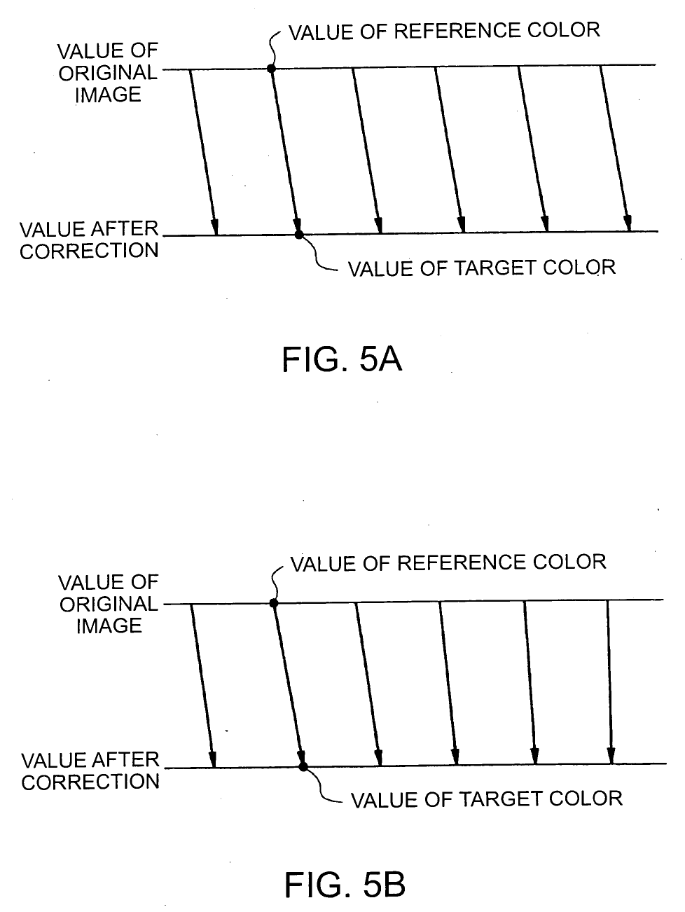

FIG. 5(a) is a schematic view for explaining an adjustment for similarly correcting an entire color space. FIG. 5(b) is a schematic view for explaining the adjustment of the correcting amount based on the difference between the characteristics of the reference color and the characteristics of the pixel of the correcting object.

Here, the value of information (e.g., hue, chroma, brightness, etc.) of one of the characteristics of the pixel in the original image and the correcting image is set on the axis of abscissa.

As shown in FIG. 5(a), all the colors are set to have the same correcting amount by the adjustment of (c1). Further, as shown in FIG. 5(b), the correcting amount is increased with respect to a color near the reference color, and the correcting amount is decreased with respect to a color large in the difference between this color and the reference color by the adjustment of (c2).

The processing condition selecting device 204 makes a user select a setting item of the image correction processing of setting of the above reference area, setting of the adjustment of the correcting amount, setting of the target color, etc. through the input device 106.

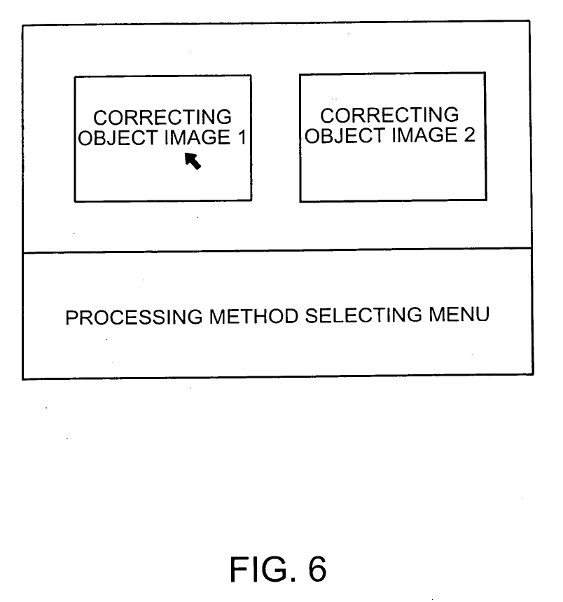

FIG. 6 is a view showing an example displaying a list of setting items of the image correction processing together with the display screen of the image of the correcting object. The user selects the setting item required in the image correction processing by utilizing the input device 106 such as a mouse, etc. Further, while the correcting image temporarily corrected is preview-displayed as a reduced image on the basis of the selected setting item by the image display device 201, an optimum setting item is retrieved and the image correction processing depending on the optimum setting item is executed.

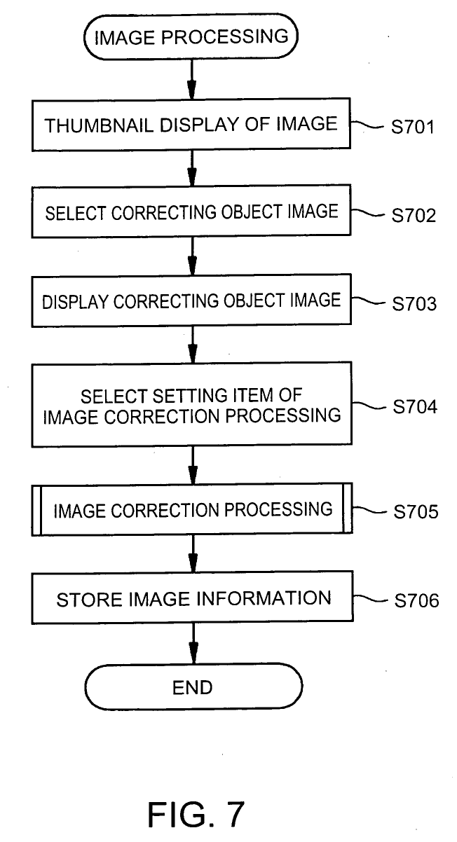

FIG. 7 shows one example of a flow chart of an exemplary image processing for generating an image corrected in the color tone by a control program stored to the ROM 102 in advance. First, the image information of plural images stored to the image information memory section 211 is read and the images are displayed in the display device 108 on the basis of the read image information (S701). Here, the image information of the original image stored to the image information memory section 211 in advance is large in information amount and plural images cannot be displayed. Therefore, the plural images can be set to be reviewed by utilizing reduction processing of the display image, a scroll of the screen, etc. Further, the images are rearranged and displayed in the image order requested from the user through the input device 106.

Next, an image as a correcting object is selected by the user from the plural images through the input device 106 (S702). As shown in FIG. 3, the user selects a reduced image as a processing object of the image correction by utilizing a mouse, etc. The reduced image selected by the user is shown by a thick frame. Next, the image is displayed in the display device 108 on the basis of the image information of the selected image (S703). As shown in FIG. 6, plural selected images are displayed.

Next, a setting item of the image correction processing of the setting of the reference area, the setting of an adjusting method of the correcting amount, the setting of the target color, etc. is selected by the user through the input device 106 (S704).

Next, the image correction processing is executed on the basis of the selected setting item of the image correction processing (S705). The image information of the correcting image finally corrected is stored to the correcting image information memory section 212 (S706).

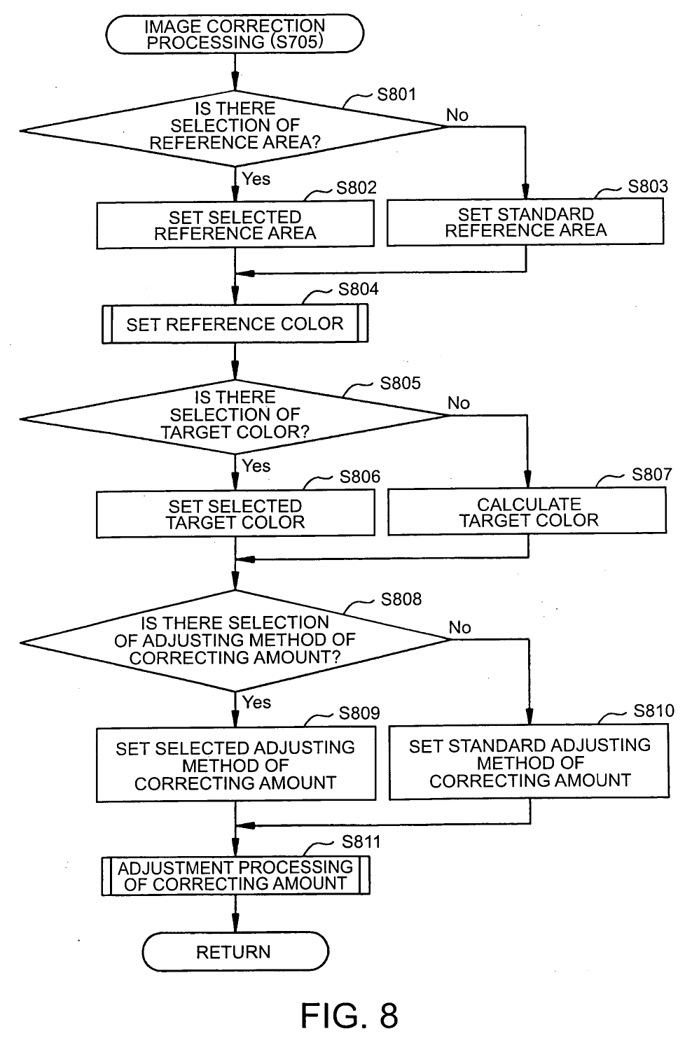

FIG. 8 shows one example of a flow chart of the image correction processing in FIG. 7. First, whether the reference area is selected by the user is judged (S801). When the reference area is selected by the user (S801; Yes), the selected reference area is set as a reference area of subsequent correction processing (S802). In contrast to this, when no reference area is selected by the user (S801; No), a standard reference area set in advance is set as a reference area of subsequent correction processing (S803).

For example, as explained in FIG. 2, (a1) to (a5) are set in advance as the reference area. When (a2) is selected as the reference area by the user, or the standard reference area is (a2), the image object area of a maximum area within plural image object areas constituting the correcting object image is set to a reference area, and the subsequent correction processing is executed. Next, on the basis of the set reference area, the reference color of the reference area in all the images as the correcting object is set (S804).

Next, whether a target color is selected by the user is judged (S805). When the target color is selected by the user (S805; Yes), the selected target color is set as a target color of the subsequent correction processing (S806). For example, one of the reference color and plural colors between the reference colors is selected by the user. When no target color is selected by the user (S805; No), the target color is calculated on the basis of the reference color of the reference area in all the images as a correcting object (S807). For example, an average value of the reference color of the reference area in all the images as the correcting object is set to the target color.

Next, whether an adjusting method of the correcting amount is selected by the user is judged (S808). When the adjusting method of the correcting amount is selected by the user (S808; Yes), the selected adjusting method of the correcting amount is set as an adjusting method of the correcting amount of subsequent correction processing (S809). In contrast to this, when adjusting method of the correcting amount is not selected by the user (S808; No), a standard adjusting method of the correcting amount set in advance is set as the adjustment of the correcting amount of subsequent correction processing (S810). For example, as explained in FIG. 2, the adjusting method of the correcting amount depending on the pixel position, the adjusting method of a correction function depending on the pixel color, etc. are set.

The image information of the image of the correcting object is finally corrected on the basis of the adjusting method of the set correcting amount (S811), and the processing is terminated.

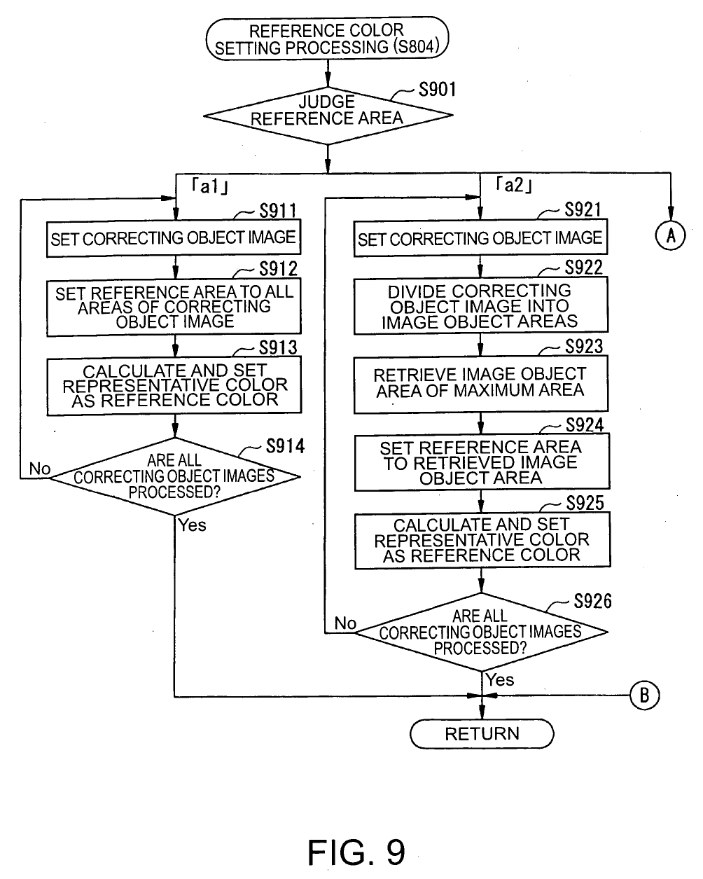

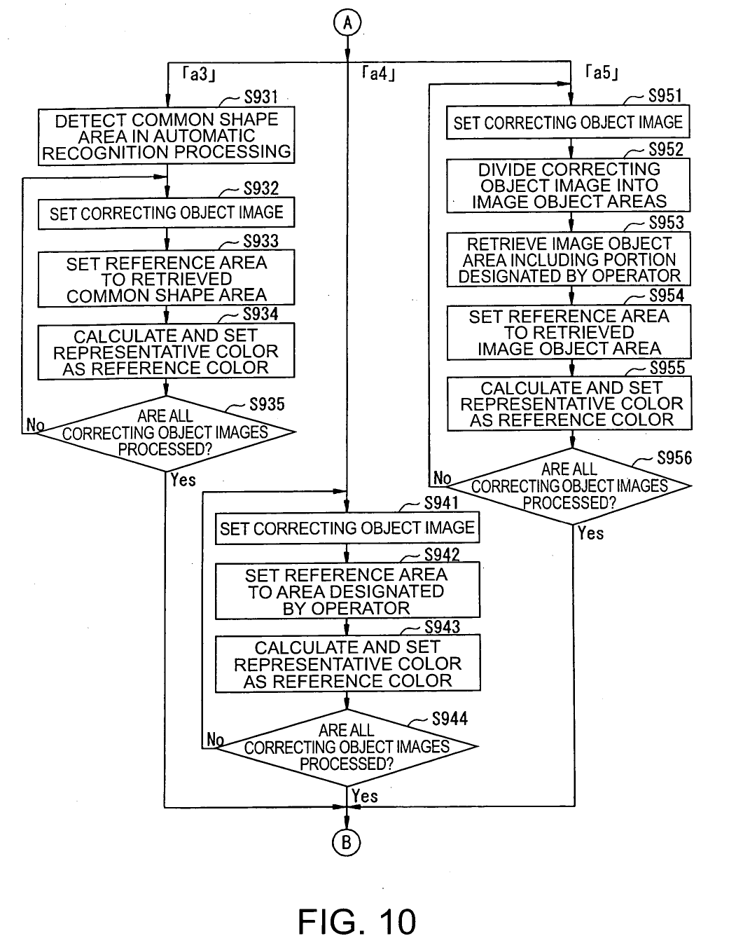

FIGS. 9 and 10 show one example of the flow chart of the reference color setting processing in FIG. 8.

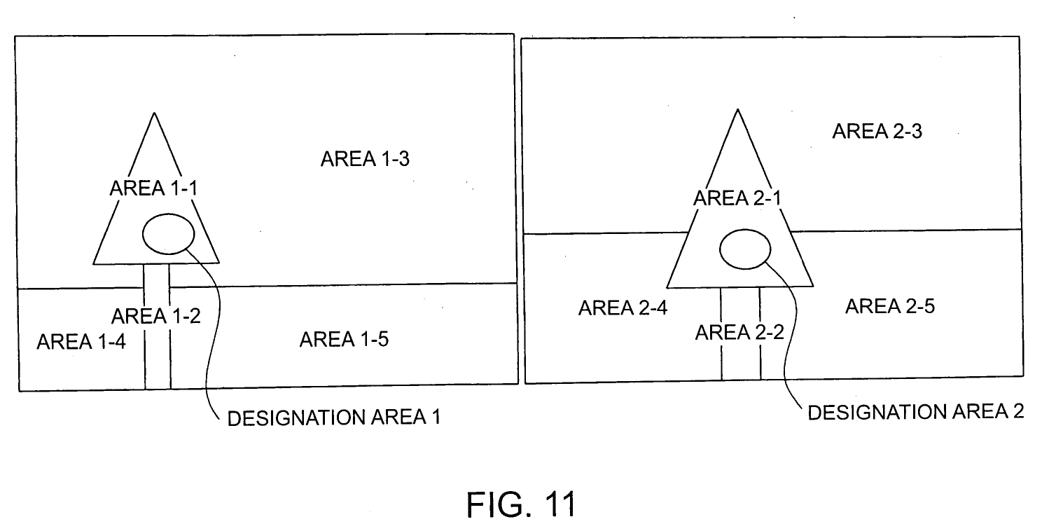

FIG. 11 shows one example of a schematic view of the correcting object image.

Here, the respective steps of FIGS. 9 and 10 will be explained with reference to FIG. 11. Further, as shown in FIG. 11, a case, when object images 1 and 2 exist, will be exemplified and explained as the correcting object image.

First, a reference area selected by a user, or a reference area set as a standard in advance is judged (S901). When the reference area is all the areas of the correcting object image (S901; “a1”), one correcting object image among plural correcting object images is first set (S911). Next, the reference area is set as all the areas of the correcting object image, and the pixel information of all pixels constituting the reference area is taken out (S912). Next, a representative color is calculated on the basis of the taken-out pixel information of the pixels, and is set as a reference color (S913). For example, a color near the color of a largest pixel number among the colors of the pixels constituting the reference area is set to the representative color, and an average value of all the colors of the pixels constituting the reference area is set to the representative color.

Next, it is judged whether the reference color is set or not with respect to all the correcting object images (S914). When an image, not having set a reference color, exists (S914; No), it is returned to the step S911, and steps S911 to S914 are repeated with respect to all the correcting object images until the reference color is set. In contrast to this, when the reference color is set with respect to all the correcting object images (S914; Yes), the processing is terminated.

As shown in FIG. 11, the reference area of the object image 1 becomes all the areas of the object image 1, and the reference color becomes the representative color of all the areas of the object image 1. The reference area of the object image 2 becomes all the areas of the object image 2, and the reference color becomes the representative color of all the areas of the object image 2.

When the reference area is the image object area of a maximum area within plural image object areas constituting the correcting object image (S901; “a2”), one correcting object image within the plural correcting object images is set (S921). Next, the correcting object image is divided into image object areas (S922), and the image object area of the maximum area is retrieved from the divided plural image object areas (S923). For example, as an area dividing method, there are an area dividing method depending on an edge judgment, etc.

Next, the retrieved image object area is set as the reference area, and the pixel information of all pixels constituting the reference area is taken out (S924). Next, a representative color is calculated on the basis of the taken-out pixel information of the pixels, and is set as a reference color (S925).

Next, it is judged whether the reference color is set or not with respect to all the correcting object images (S926). When an image, not having set a reference color, exists (S926; No), it is returned to the step S921 and steps S921 to S926 are repeated until the reference color is set with respect to all the correcting object images. In contrast to this, when the reference color is set with respect to all the correcting object images (S926; Yes), the processing is terminated.

As shown in FIG. 11, the object image 1 is divided into five image object areas of areas 1-1 to 1-5, and the object image 2 is divided into five image object areas of areas 2-1 to 2-5. When the image object area of a maximum area is retrieved within each image, the area 1-3 is retrieved in the object image 1 and the area 2-3 is retrieved in the object image 2. Accordingly, the reference area of the object image 1 becomes the area 1-3 and the reference color becomes the representative color of the area 1-3. Further, the reference area of the object image 2 becomes the area 2-3 and the reference color becomes the representative color of the area 2-3.

When the reference area is an area recognized as a common shape existing within the plural correcting object images (S901; “a3”), the common shape among the plural correcting object images is first automatically recognized and the area of the recognized common shape is detected (S931). Next, one correcting object image within the plural correcting object images is set (S932), and the area of the detected common shape is set as the reference area, and the pixel information of all pixels constituting the reference area is taken out (S933). Next, the representative color is calculated on the basis of the taken-out pixel information of the pixels, and is set as the reference color (S934).

Next, it is judged whether the. reference color is set or not with respect to all the correcting object images (S935). When an image, not having set a reference color, exists (S935; No), it is returned to the step S932 and steps S932 to S935 are repeated until the reference color is set with respect to all the correcting object images. In contrast to this, when the reference color is set with respect to all the correcting object images (S935; Yes), the processing is terminated.

As shown in FIG. 11, when areas 1-1 and 2-1 are recognized as the common shape existing within the object images 1 and 2, the reference area of the object image 1 becomes the area 1-1 and the reference color becomes the representative color of the area 1-1. Further, the reference area of the object image 2 becomes the area 2-1 and the reference color becomes the representative color of the area 2-1. Further, when plural areas recognized as the common shape exist in each image, the reference color is set with each area as the reference area.

When the reference area is an area within the correcting object image designated by a user (S901; “a4”), one correcting object image within the plural correcting object images is first set (S941). Next, the reference area is set as the area designated by the user, and the pixel information of all pixels constituting the reference area is taken out (S942). Next, the representative color is calculated on the basis of the taken-out pixel information of the pixels, and is set as the reference color (S943).

It is next judged whether the reference color is set or not with respect to all the correcting object images (S944). When an image, not having set a reference color, exists (S944; No), it is returned to the step S941 and steps S941 to S944 are repeated until the reference color is set with respect to all the correcting object images. In contrast to this, when the reference color is set with respect to all the correcting object images (S944; Yes), the processing is terminated.

As shown in FIG. 11, when the areas designated by the user in the object images 1 and 2 are respectively designation areas 1 and 2, the reference area of the object image 1 becomes the designation area 1 and the reference color becomes the representative color of the designation area 1. Further, the reference area of the object image 2 becomes the designation area 2 and the reference color becomes the representative color of the designation area 2.

When the reference area is the image object area including the area within the correcting object image designated by the user (S901; “a5”), one correcting object image within the plural correcting object images is first set (S951). Next, the correcting object image is divided into image object areas (S952), and the image object area including the area designated by the user is retrieved from the divided plural image object areas (S953).

Next, the retrieved image object area is set as the reference area, and the pixel information of all pixels constituting the reference area is taken out (S954). Next, the representative color is calculated on the basis of the taken-out pixel information of the pixels and is set as the reference color (S955).

Next, it is judged whether the reference color is set or not with respect to all the correcting object images (S956). When an image, not having set a reference color, exists (S956; No), it is returned to the step S951 and steps S951 to S956 are repeated until the reference color is set with respect to all the correcting object images. In contrast to this, when the reference color is set with respect to all the correcting object images (S956; Yes), the processing is terminated.

As shown in FIG. 11, when the areas designated by the user in the object images 1 and 2 are respectively designation areas 1 and 2, the image object area including the designation area 1 is the area 1-1 and the image object area including the designation area 2 is the area 2-1. Accordingly, the reference area of the object image 1 becomes the area 1-1, and the reference color becomes the representative color of the area 1-1. Further, the reference area of the object image 2 becomes the area 2-1 and the reference color becomes the representative color of the area 2-1.

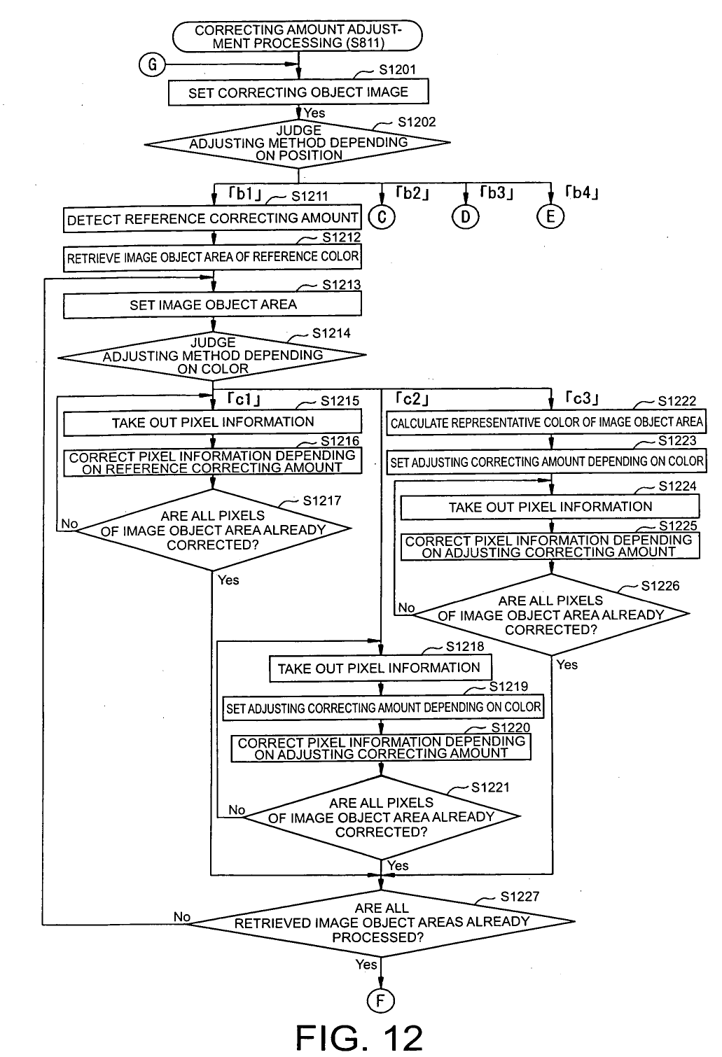

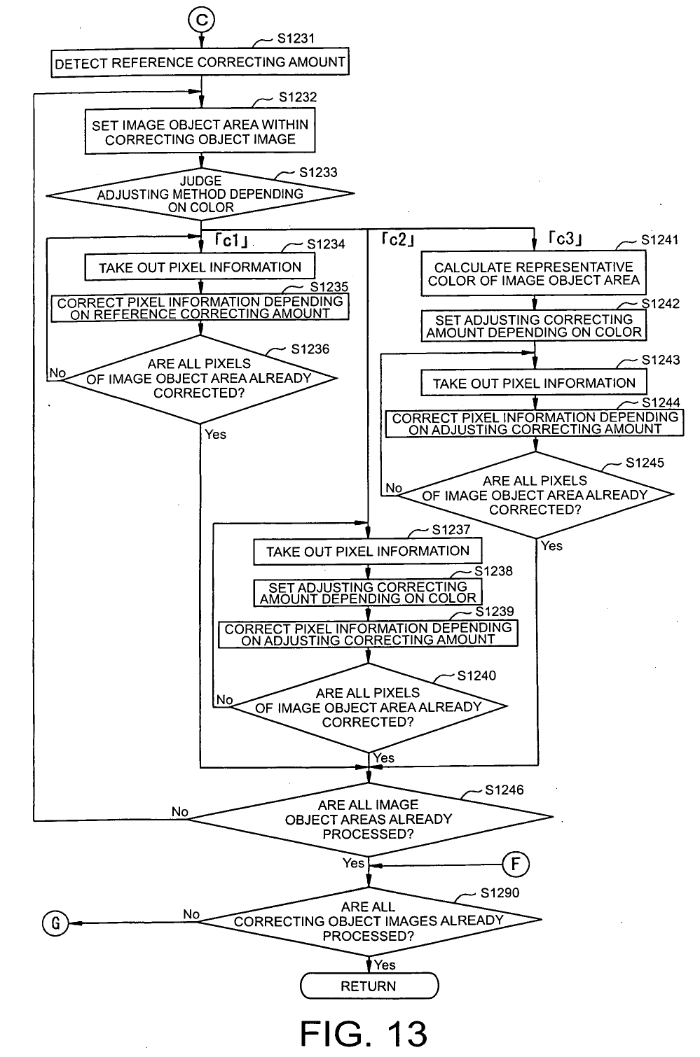

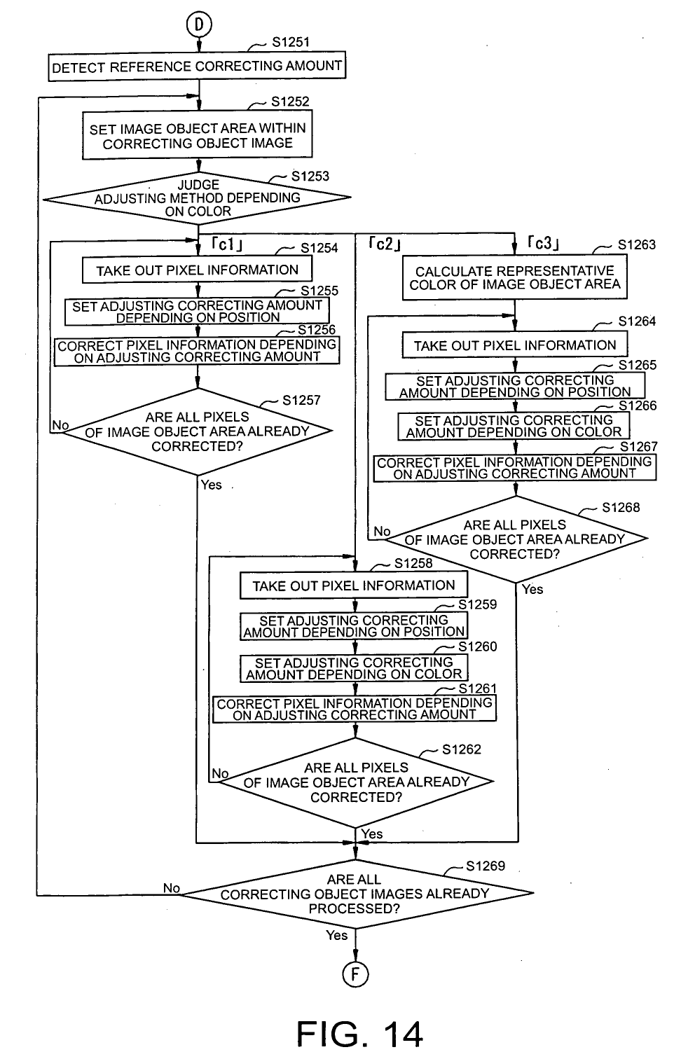

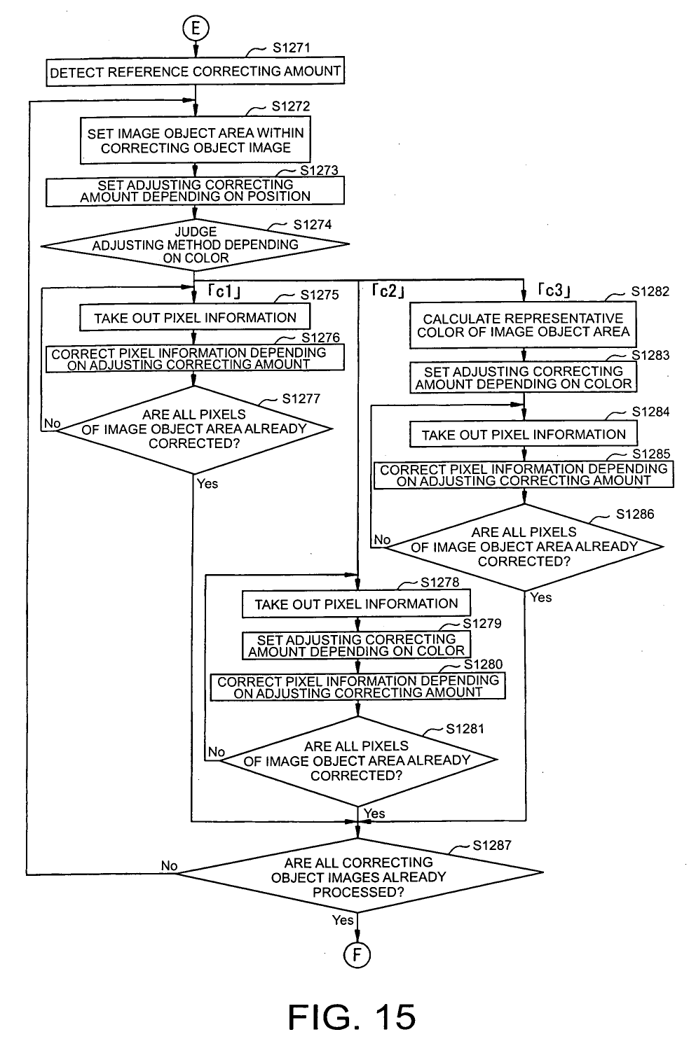

FIGS. 12 to 15 show one example of the flow chart of the correcting amount adjustment processing in FIG. 8.

First, one correcting object image within plural correcting object images is set (S1201). Next, the adjusting method of a correcting amount depending on the position of a pixel selected by a user, or the adjusting method of a correcting amount set in advance as a standard is judged (S1202).

When the adjusting method of the correcting amount is an adjusting method for correcting the color tone of the pixel with respect to only the pixel existing in the image object area including the reference color and a color near the reference color (S1202; “b1”), a reference correcting amount detected on the basis of the reference color and a target color is set as the correcting amount (S1211). Next, the image object area including the reference color and the color near the reference color is retrieved (S1212).

Next, one image object area of a correcting object is set from the plural retrieved image object areas (S1213). Next, the adjusting method of the correcting amount depending on the color of the pixel selected by the user, or the adjusting method of the correcting amount set in advance as a standard is judged (S1214).

When the adjusting method of the correcting amount depending on the color of the pixel selected by the user is an adjusting method for adjusting the correcting amount so as to be constant irrespective of the characteristics of the pixel color (S 1214; “c1”), the pixel information of the pixel as a correcting object within the retrieved image object areas is taken out (S1215), and the pixel information of the pixel is corrected by the set reference correcting amount (S1216).

It is next judged whether the pixel information of all the pixels constituting the image object area is updated or not (S1217). When pixel information of all the pixels is not updated (S1217; No), it is returned to the step S1215 and steps S1215 to S1217 are repeated until the pixel information of all the pixels is updated. Then, it proceeds to the next step S1227.

When the adjusting method of the correcting amount depending on the pixel color selected by the user is an adjusting method for adjusting the correcting amount with respect to the pixel on the basis of the difference between the characteristics of the reference color and the characteristics of the pixel color such that this correcting amount is reduced as the difference is increased (S1214; “c2”), the pixel information of the pixel as the correcting object within the retrieved image object areas is taken out (S1218). On the basis of the difference between the characteristics of the reference color and the characteristics of the pixel of the correcting object, a correcting amount (hereinafter called “an adjusting correcting amount”) provided by adjusting the reference correcting amount is set (S1219), and the pixel information of the pixel is corrected by the adjusting correcting amount (S1220).

It is next judged whether the pixel information of all the pixels constituting the image object area is updated or not (S1221). When pixel information of all the pixels is not updated (S1221; No), it is returned to the step 1218, and steps S1218 to S1221 are repeated until the pixel information of all the pixels is updated. It then proceeds to the next step S1227.

When the adjusting method of the correcting amount depending on the pixel color selected by the user is an adjusting method for adjusting the correcting amount with respect to the pixel on the basis of the difference between the characteristics of the reference color and the characteristics of the representative color of the image object area to which the pixel belongs such that this correcting amount is reduced as the difference is increased (S1214; “c3”), the representative color of the retrieved image object area is calculated (S1222). The adjusting correcting amount provided by adjusting the reference correcting amount is set on the basis of the difference between the characteristics of the reference color and the characteristics of the calculated representative color (S1223). Next, the pixel information of the pixel as the correcting object within the retrieved image object area is taken out (S1224), and the pixel information of the pixel is corrected by the adjusting correcting amount (S1225).

It is next judged whether the pixel information of all the pixels constituting the image object area is updated or not (S1226). When pixel information of all the pixels is not updated (S1226; No), it is returned to the step S1224 and steps S1224 to S1226 are repeated until the pixel information of all the pixels is updated. It then proceeds to the next step S1227.

It is next judged whether the correction processing is executed or not with respect to all the image object areas retrieved in the step S1212 (S1227). When correction processing is not executed with respect to all the image object areas (S1227; No), it is returned to the step S1213 and steps S1213 to S1227 are repeated until the correction processing is executed with respect to all the image object areas. It then proceeds to the next step S1290.

When the adjusting method of the correcting amount is an adjusting method for correcting the color tone of the pixel with respect to all the pixels of the correcting object image (S1202; “b2”), a reference correcting amount detected on the basis of the reference color and the target color is first set as the correcting amount (S1231). Next, one image object area within the correcting object image is set (S1232). Next, the adjusting method of the correcting amount depending on the pixel color selected by the user, or the adjusting method of the correcting amount set in advance as a standard is judged (S1233).

When the adjusting method of the correcting amount depending on the pixel color selected by the user is an adjusting method for adjusting the correcting amount so as to be constant irrespective of the characteristics of the pixel color (S1233; “c1”), the pixel information of the pixel as the correcting object within the image object area is taken out (S1234) and the pixel information of the pixel is corrected by the set reference-correcting amount (S1235).

It is next judged whether the pixel information of all the pixels constituting the image object area is updated or not (S1236). When pixel information of all the pixels is not updated (S1236; No), it is returned to the step S1234 and steps S1234 to S1236 are repeated until the pixel information of all the pixels is updated. It then proceeds to the next step S1246.

When the adjusting method of the correcting amount depending on the pixel color selected by the user is an adjusting method for adjusting the correcting amount with respect to the pixel on the basis of the difference between the characteristics of the reference color and the characteristics of the pixel color such that this correcting amount is reduced as the difference is increased (S1233; “c2”), the pixel information of the pixel as the correcting object within the image object area is taken out (S1237). An adjusting correcting amount provided by adjusting the reference correcting amount is then set on the basis of the difference between the characteristics of the reference color and the characteristics of the pixel of the correcting object (S1238), and the pixel information of the pixel is corrected by the adjusting correcting amount (S1239).

It is next judged whether the pixel information of all the pixels constituting the image object area is updated or not (S1240). When pixel information of all the pixels is not updated (S1240; No), it is returned to the step S1237 and steps S1237 to S1240 are repeated until the pixel information of all the pixels is updated. It then proceeds to the next step S1246.

When the adjusting method of the correcting amount depending on the pixel color selected by the user is an adjusting method for adjusting the correcting amount with respect to the pixel on the basis of the difference between the characteristics of the reference color and the characteristics of the representative color of the image object area to which the pixel belongs such that this correcting amount is reduced as the difference is increased (S1232; “c3”), a representative color of the image object area is calculated (S1241) and an adjusting correcting amount provided by adjusting the reference correcting amount is set on the basis of the difference between the characteristics of the reference color and the characteristics of the calculated representative color (S1242). Next, the pixel information of the pixel as the correcting object within the image object area is taken out (S1243), and the pixel information of the pixel is corrected by the adjusting correcting amount (S1244).

It is next judged whether the pixel information of all the pixels constituting the image object area is updated or not (S1245). When pixel information of all the pixels is not updated (S1245; No), it is returned to the step S1243 and steps S1243 to S1245 are repeated until the pixel information of all the pixels is updated. It then proceeds to the next step S1246.

It is next judged whether the correction processing is executed or not with respect to all the image object areas of the correcting object image (S1246). When correction processing is not executed with respect to all the image object areas (S1246; No), it is returned to the step S1232 and steps S1232 to S1246 are repeated until the correction processing is executed with respect to all the image object areas. It then proceeds to the next step S1290.

When the adjusting method of the correcting amount is an adjusting method for adjusting the correcting amount with respect to the pixel on the basis of the distance between the reference area and the pixel such that this correcting amount is reduced as the distance is increased (S1202; “b3”), a reference correcting amount detected on the basis of the reference color and the target color is first set as the correcting amount (S1251). Next, one image object area within the correcting object image is set (S1252). Next, the adjusting method of the correcting amount depending on the pixel color selected by the user, or the adjusting method of the correcting amount set in advance as a standard is judged (S1253).

When the adjusting method of the correcting amount depending on the pixel color selected by the user is an adjusting method for adjusting the correcting amount so as to be constant irrespective of the characteristics of the pixel color (S1253; “c1”), the pixel information of the pixel as the correcting object within the image object area is taken out (S1254). The distance between the reference area and the pixel is then calculated and an adjusting correcting amount provided by adjusting the reference correcting amount on the basis of the calculated distance is set (S1255). Further, the pixel information of the pixel is corrected by the adjusting correcting amount (S1256).

It is next judged whether the pixel information of all the pixels constituting the image object area is updated or not (S1257). When pixel information of all the pixels is not updated (S1257; No), it is returned to the step S1254 and steps S1254 to S1257 are repeated until the pixel information of all the pixels is updated. It then proceeds to the next step S1269.

When the adjusting method of the correcting amount depending on the pixel color selected by the user is an adjusting method for adjusting the correcting amount with respect to the pixel on the basis of the difference between the characteristics of the reference color and the characteristics of the pixel color such that this correcting amount is reduced as the distance is increased (S1253; “c2”), the pixel information of the pixel as the correcting object within the image object area is taken out (S1258). The distance between the reference area and the pixel is then calculated and an adjusting correcting amount provided by adjusting the reference correcting amount is set on the basis of the calculated distance (S1259). Next, an adjusting correcting amount provided by further adjusting the adjusting correcting amount adjusted in the step S1259 is set on the basis of the difference between the characteristics of the reference color and the characteristics of the pixel of the correcting object (S1260). Then, the pixel information of the pixel is corrected by the further adjusting correcting amount (S1261).

It is next judged whether the pixel information of all the pixels constituting the image object area is updated or not (S1262). When pixel information of all the pixels is not updated (S1262; No), it is returned to the step S1258 and steps S1258 to S1262 are repeated until the pixel information of all the pixels is updated. It then proceeds to the next step S1269.

When the adjusting method of the correcting amount depending on the pixel color selected by the user is an adjusting method for adjusting the correcting amount with respect to the pixel on the basis of the difference between the characteristics of the reference color and the characteristics of the representative color of the image object area to which the pixel belongs such that this correcting amount is reduced as the difference is increased (S1253; “c3”), the representative color of the image object area is calculated (S1263). Next, the pixel information of the pixel as the correcting object within the image object area is taken out (S1264), and the distance between the reference area and the pixel is calculated and an adjusting correcting amount provided by adjusting the reference correcting amount is set on the basis of the calculated distance (S1265).

Next, an adjusting correcting amount provided by further adjusting the adjusting correcting amount adjusted in the step S1265 is set on the basis of the difference between the characteristics of the reference color and the characteristics of the calculated representative color (S1266). Then, the pixel information of the pixel is corrected by the further adjusting correcting amount (S1267).

It is next judged whether the pixel information of all the pixels constituting the image object area is updated or not (S1268). When pixel information of all the pixels is not updated (S1268; No), it is returned to the step S1264 and steps S1264 to S1268 are repeated until the pixel information of all the pixels is updated. It then proceeds to the next step S1269.

It is next judged whether the correction processing is executed or not with respect to all the image object areas of the correcting object image (S1269). When correction processing is not executed with respect to all the image object areas (S1269; No), it is returned to the step S1252 and steps S1252 to S1269 are repeated until the correction processing is executed with respect to all the image object areas. It then proceeds to the next step S1290.

When the adjusting method of the correcting amount is an adjusting method for adjusting the correcting amount with respect to the pixel on the basis of the distance between the reference area and the image object area to which the pixel belongs such that this correcting amount is reduced as the distance is increased (S1202; “b4”), a reference correcting amount detected on the basis of the reference color and a target color is first set as the correcting amount (S1271). Next, one image object area within the correcting object image is set (S1272). Next, the distance between the reference area and the set image object area is calculated and an adjusting correcting amount provided by adjusting the reference correcting amount on the basis of the calculated distance is set (S1273). Next, the adjusting method of the correcting amount depending on the pixel color selected by the user, or the adjusting method of the correcting amount set in advance as a standard is judged (S1274).

When the adjusting method of the correcting amount depending on the pixel color selected by the user is an adjusting method for adjusting the correcting amount so as to be constant irrespective of the characteristics of the pixel color (S1274; “c1”), the pixel information of the pixel as the correcting object within the image object area is taken out (S1275) and the pixel information of the pixel is corrected by the adjusting correcting amount adjusted in the step S1273 (S1276).

It is next judged whether the pixel information of all the pixels constituting the image object area is updated or not (S1277). When pixel information of all the pixels is not updated (S1277; No), it is returned to the step S1275 and steps S1275 to S1277 are repeated until the pixel information of all the pixels is updated. It then proceeds to the next step S1287.

When the adjusting method of the correcting amount depending on the pixel color selected by the user is an adjusting method for adjusting the correcting amount with respect to the pixel on the basis of the difference between the characteristics of the reference color and the characteristics of the pixel color such that this correcting amount is reduced as the difference is increased (S1274; “c2”), the pixel information of the pixel as the correcting object within the image object area is taken out (S1278). An adjusting correcting amount provided by further adjusting the adjusting correcting amount adjusted in the step S1273 on the basis of the difference between the characteristics of the reference color and the characteristics of the pixel of the correcting object is set (S1279). Then, the pixel information of the pixel is corrected by the further adjusting correcting amount (S1280).

It is next judged whether the pixel information of all the pixels constituting the image object area is updated or not (S1281). When pixel information of all the pixels is not updated (S1281; No), it is returned to the step S1278 and steps S1278 to S1281 are repeated until the pixel information of all the pixels is updated. It then proceeds to the next step S1287.

When the adjusting method of the correcting amount depending on the pixel color selected by the user is an adjusting method for adjusting the correcting amount with respect to the pixel on the basis of the difference between the characteristics of the reference color and the characteristics of the representative color of the image object area to which the pixel belongs such that this correcting amount is reduced as the distance is increased (S1274; “c3”), the representative color of the image object area is calculated (S1282). An adjusting correcting amount provided by further adjusting the adjusting correcting amount adjusted in the step S1273 on the basis of the difference between the characteristics of the reference color and the characteristics of the calculated representative color is set (S1283). Next, the pixel information of the pixel as the correcting object within the image object area is taken out (S1284) and the pixel information of the pixel is corrected by the further adjusting correcting amount (S1285).

It is next judged whether the pixel information of all the pixels constituting the image object area is updated or not (S1286). When pixel information of all the pixels is not updated (S1286; No), it is returned to the step S1284 and steps S1284 to S1286 are repeated until the pixel information of all the pixels is updated. It then proceeds to the next step S1287.

It is next judged whether the correction processing is executed with respect to all the image object areas of the correcting object image or not (S1287). When correction processing is not executed with respect to all the image object areas (S1287; No), it is returned to the step S1272 and steps S1272 to S1287 are repeated until the correction processing is executed with respect to all the image object areas. It then proceeds to the next step S1290.

It is finally judged whether the correction processing is executed or not with respect to all the correcting object images (S1290). When correction processing is not executed with respect to all the correcting object images (S1290; No), it is returned to the step S1201 and steps S1201 to S1290 are repeated until the correction processing is executed with respect to all the correcting object images. The processing is then terminated.

As mentioned above, the image processor 100 has the image display device 201, the image selecting device 202, the image correcting device 203 and the processing condition selecting device 204. The image correcting device 203 has the reference color setting device 221, the target color setting device 222 and the pixel information correcting device 223. Further, the pixel information correcting device 223 has the correcting amount detecting device 231 and the correcting amount adjusting device 232. Accordingly, when plural images of different color tones in accordance with a photographing condition, etc. are arranged on the same page, the oddness of appearance of the color tone of the image can be reduced. Further, the image can be easily corrected for every image or photographed object without performing a complicated setting operation of the correction processing by the user. Further, the image correction processing can be performed irrespective of the photographed condition, etc. merely by selecting an image for unifying the color tone of the image by the user. Accordingly, the user can perform the operation of the image correction even when user has no special ability and skill.

Further, when the area of the above (a1) is set to the reference area, largest color tones within plural correcting object images can be conformed by setting a color near the color of high frequency to a reference color in the pixel of the correcting object image.

Further, when the area of (a2) is set to the reference area, the color tones can be conformed with a background portion of the plural correcting object images as a reference in e.g., an image in which the background occupies a large area.

Further, when the area of (a3) is set to the reference area, the color tones of the image object areas common to the plural correcting object images can be conformed.

Further, when the area of (a4) is set to the reference area, the user can select an area to be clearly conformed.

Further, when the area of (a5) is set to the reference area, it is possible to select the image object area to be clearly conformed even when a portion designated by the user is one point of the image object area.

Further, the image correction can be made by adjusting the correcting amount of the above (b1) with respect to only the pixel belonging to the image object area including the reference color and a color near the reference color.

Further, the image correction can be made with respect to all the belonging pixels of the correcting object image by adjusting the correcting amount of (b2).

Further, while the correcting amount of the color tone of the pixel of a specific reference area within the correcting object image is uniformly corrected by adjusting the correcting amount of (b3), the correcting amount of the color tone of the pixel is reduced as the pixel is separated from the reference area, and it is possible to avoid the oddness of appearance in the color tones of the reference area and its circumference.

Further, while the correcting amount of the color tone of the pixel of a specific reference area within the correcting object image is uniformly corrected by adjusting the correcting amount of (b4), the correcting amount of the color tone of the pixel of the image object area separated from the reference area is reduced, and the oddness of appearance in the color tones of the reference area and its circumference is avoided. Further, the pixel of the image object area can be uniformly corrected. Accordingly, in the adjustment of (b3), a different correcting amount is applied although it is the pixel within the same image object area. Accordingly, when the image object area of the correcting image becomes unnatural, (b4) can be applied to set the correcting amount with respect to the pixel within the image object area to the same.

Further, the image correction can be made by the same correcting amount with respect to the pixels of all the colors by adjusting the correcting amount of the above (c1). Accordingly, it is effective when the color tone of the entire image is shifted in one direction by the influence of a light source at a photographing time and the characteristics of a photographing device.

Further, the correcting amount is increased with respect to a color near the reference color and is reduced with respect to a color having a large difference with the reference color by adjusting the correcting amount of (c2) so that the correction of the pixel of a color separated from the reference color can be avoided.

Further, the correcting amount of the pixel of the image object area with a color near the reference color as a representative color is uniformly increased, and the correcting amount of the pixel of the image object area with a color having a large difference with the reference color as a representative color is uniformly reduced for every image object area by adjusting the correcting amount of (c3). Thus, the correction of the pixel of the image object area with a color separated from the reference color as a representative color is avoided, and the pixel of the image object area can be uniformly corrected.

When processings shown in the above flow charts of FIGS. 7 to 10 and FIGS. 12 to 15 are executed, the control program stored to the ROM 102 in advance is executed in the above explanation. However, this program may be read to the RAM 103 from an information recording medium recording the program for executing each of these processes, and may be executed.

Here, the information recording medium is a semiconductor recording medium, such as RAM, ROM, a magnetic memory type recording medium such as FD, HD, an optical reading system recording medium such as CD, CDV, LD, DVD, a magnetic memory type/optical reading system recording medium such as MO. All information recording media are included if the information recording media are information recording media capable to be read by a computer irrespective of electronic, magnetic, optical reading systems, and the like.

The above embodiment are described for the explanation and do not limit the scope of the present invention. Accordingly, a person skilled in the art can adopt embodiment in which each of these elements or all the elements are replaced with equivalent elements. However, these embodiment are also included in the scope of the present invention.

What is claimed is:

1. An image processor for unifying color tones of plural correcting object images, the image processor comprising:
an image selecting device that selects the plural correcting object images as a correcting object from plural images; and
an image correcting device that selects a reference color which is a representative color of the correcting object for every correcting object image, and corrects the color tone of the correcting object image such that the reference colors set for every image to be corrected conform.

2. The image processor according to claim 1, the image processor further comprising a processing condition selecting device that makes a user select one or plural correction processing conditions of the correction processing executed by said image correcting device through an input device.

3. The image processor according to claim 1, said image correcting device further comprising:
a reference color setting device that sets a reference area which is a partial area or an entire area of the correcting object image for every said correcting object image, and sets the representative color calculated on a basis of pixel information of a pixel constituting said set reference area as the reference color;
a target color setting device that sets, as a target color, a color after the correction common to said each correcting object image when said reference colors set for every said correcting object image by said reference color setting device are conformed; and
a pixel information correcting device that sets the correcting amount of the color tone of said each pixel in accordance with a changing degree when said reference color is changed to said target color, and corrects said pixel information of said each pixel on the basis of said set correcting amount.

4. The image processor according to claim 3, at least one of the following areas being set as said reference area,
all areas of said correcting object image,
said image object area having a maximum area within plural image object areas constituting said correcting object image,
an area recognized as a common shape and existing within said plural correcting object images,
an arbitrary area within said correcting object image designated by a user through an input device, and
said image object area of the correcting object image including an arbitrary portion within said correcting object image designated by a user through the input device.

5. The image processor according to claim 3, said pixel information correcting device correcting said correcting amount of said pixel information of the pixel with respect to only said pixel existing in the image object area including said reference color and a color near said reference color.

6. The image processor according to claim 3, said pixel information correcting device correcting said correcting amount of said pixel information of the pixel with respect to all said pixels of said correcting object image.

7. The image processor according to claim 3, said pixel information correcting device comprising:
a correcting amount detecting device that detects said correcting amount when said reference color is changed to said target color so as to conform said reference color and said target color; and
a correcting amount adjusting device that adjusts the correcting amount of said pixel information of the pixel on the basis of said pixel information of said pixel as the correcting object of said correcting object image and said correcting amount detected by said correcting amount detecting device.

8. The image processor according to claim 7, said correcting amount adjusting device adjusting the correcting amount in accordance with a distance between said reference area and said pixel.

9. The image processor according to claim 7, said correcting amount adjusting device adjusting the correcting amount in accordance with a distance between said reference area and said image object area to which said pixel belongs.

10. The image processor according to claim 7, said correcting amount adjusting device adjusting said correcting amount so as to be constant irrespective of characteristics of the color of said pixel.

11. The image processor according to claim 7, said correcting amount adjusting device adjusting the correcting amount in accordance with a difference between characteristics of said reference color and characteristics of a color of said pixel.

12. The image processor according to claim 7, said correcting amount adjusting device adjusting the correcting amount in accordance with a difference between characteristics of said reference color and characteristics of the representative color of said image object area to which the pixel belongs.

13. An image processing method for unifying the color tones of plural correcting object images, comprising:
an image selecting process for selecting said plural correcting object images as a correcting object from plural images; and
an image correcting process for setting a reference color which is a representative color of the correcting object image for every said correcting object image, and correcting the color tone of said correcting object image so as to conform said reference colors set for every said correcting object image.

14. The image processing method according to claim 13, the image processing method further comprising a processing condition selecting process for making a user select one or plural correction processing conditions of the correction processing executed by said image correcting process through an input device.

15. A program for executing image processing for unifying color tones of plural correcting object images by a computer, and executing the following respective processes of an image processing method by the computer;
an image selecting process for selecting said plural correcting object images as a correcting object from plural images; and
an image correcting process for setting a reference color which is a representative color of the correcting object image for every said correcting object image, and correcting the color tone of said correcting object image so as to conform said reference colors set for every said correcting object image.

16. The program according to claim 15, the computer further executing a processing condition selecting process for making a user select one or plural correction processing conditions of the correction processing executed by said image correcting process through an input device.
